(19) United States
(12) Patent Application Publication
(10) Pub. No.: US 2008/0209853 A1
(43) Pub. Date: Sep. 4, 2008

(54) Handrail for toddlers

(76) Inventor: Anthony A. Hull, Canton, GA (US)

Correspondence Address: Harry I. Leon, 924 Bowen St. NW, Atlanta, GA, 30318, US

(21) Appl. No.: 12/079,442

(22) Filed: Mar. 27, 2008

Related U.S. Application Data
(63) Continuation-in-part of application No. 11/295,050, filed on Dec. 6, 2005.

(51) Int. Cl. E04C 3/02; F16L 3/26

(52) U.S. Cl. 52/832; 248/73

(57) ABSTRACT

A handrail system (10) for young children which is mountable on the balusters (51) of an existing handrail. Easily raised to accommodate a child as he grows, the handrail system (10) comprises at least one holding cup (23), a rail segment (11) and a support bracket (20) affixed thereto. The holding cup (23) includes a bifurcated structure with a pair of opposing concave walls which extend outwardly from their respective shoulders (24). In assembled relation, a flat-faced flange (21) which anchors the the support bracket (20) is slideably receivable between the opposing concave walls. Clampable onto a baluster (51) in such a way that they encircle a short portion of it, the flange (21) and the holding cup (23) define, respectively, a pair of elongated, opposing curvilinear slots (12, 32; 22, 42) and holes (25) in the shoulders (24) for threadedly engaging screws (29) fitted into the slots. Prior to tightening the screws (29), one can adjust the tilt of the rail segment (11) by rotating the flange (21) within the holding cup (23).

### TECHNICAL FIELD

This invention relates generally to handrail systems for young children.

### BACKGROUND ART

Most children under 5 years of age cannot safely use handrails which have been mounted in residences, schools and businesses at building code-specified heights. The latter require handrails to be mounted about 36 inches (91 cm) above stair treads. As actual tests have shown, 28 inches (71 cm) is the height above stair treads at which one needs to mount a handrail in order for most toddlers to easily reach and grip it. Further, even if the child were able to stretch and reach up to touch a handrail mounted at a standard height, the handrail typically would be too thick for the child's hand to grasp. Thus, when youngsters are in their most unstable ambulatory period and just learning to walk, the activity of climbing and descending stairs is a very dangerous one for them. Therefore, a handrail system suitable for young children is needed.

Earlier, in U.S. patent application Ser. No. 11/295,050 filed on Dec. 6, 2005, the applicant disclosed an improved handrail system which included a plurality of rail segments and support brackets affixed thereto mountable either on the, underside of an existing standard height handrail or directly on the wall adjacent to a stairway. Unfortunately, this previous handrail system was not adjustably mounted; and the handrail could not be easily raised to accommodate the child as he or she grew.

### DISCLOSURE OF THE INVENTION

The object of this invention is to provide a handrail system adjustably mountable on the balusters of an existing handrail. Intended for use by children ranging in age from about one-half year to twelve years, the handrail system affords a handrail which can be raised to the ideal height for the individual child as he or she grows.

A further object of the present invention is to provide such a handrail which not only does not interfere with the use of a handrail mounted at a standard height but also is attractive and can be easily installed by the homeowner.

The improved handrail system of the present invention comprises at least one rail segment, a support bracket affixed thereto, and means, including a holding cup, for adjustably mounting the support bracket on one of the balusters of an existing handrail. Each support bracket comprises a rail segment holder, a base, and a curved column which is juxtaposed between and rigidly attached to both the rail segment holder and the base. The base includes a generally circular flange bounded by a short side wall which terminates, distal from the curved beam, in a flat face.

In assembled relation, the flange of the support bracket and the holding cup are fastened together in such a way that they define a first through passageway within which a short portion of one of the balusters can be received. The rest of the baluster then protrudes vertically past the opposing ends of the first through passageway whenever the flange and the holding cup encircle and are clamped together onto the short portion of the baluster.

In the preferred embodiment, the holding cup is a molded piece having a single unitary structure which is bifurcated and, when mounted in use, has generally the shape of an “U” lying on its side. Defined by the bifurcated structure is a pair of opposing concave walls which are disposed on the interior surfaces of the legs of the “U”. Formed with radii of curvature which are approximately equal to the radius of curvature of the side wall of the flange, the opposing concave walls of the holding cup are spaced apart from each other a distance which is wide enough to allow the flange to be slideably received between said opposing concave walls.

Means for pulling together the flange and the holding cup so that in use they can be clamped onto one of the balusters includes a set of screws, at least one pair of elongated, curvilinear slots which oppose each other and are formed generally concentrically in the flat face of the flange, and a pair of holes defined by shoulders deep within the holding cup, the holes being disposed proximate with the innermost edges of the opposing concave walls. In assembled relation, each screw is received by one of the slots and threadedly engages one of the holes.

Prior to tightening the screws, one can, by rotating the flange while it is slideably received between the opposing concave walls, adjust the tilt of the support bracket. In this manner, any rail segment affixed to the rail segment holder can be brought into parallel alignment with the longitudinal centerline of the existing handrail. Once the screws have been threadedly engaged with the holes so as to clamp the flange and the holding cup together onto one of the balusters, the tilt of the support bracket is determined by just where along the curved arcs of the opposing pair of slots the screws received therein are held in use.

In the preferred embodiment, the flat face of the flange defines two pairs of elongated, curvilinear slots which are formed generally concentrically therein. The relative positions of the first and second pairs of slots are such that they can be used with right-handed and left-handed handrails, respectively.

In order to accommodate the existing spacing between balusters when two or more support brackets are needed to support a rail segment, each rail segment holder defines a second through passageway which is capable of receiving a short portion of the rail segment disposed anywhere along its length. That is, the passageway in the holder is not limited, as in the cited prior art, to receiving only an end of the rail segment. Form-fitted into the second through passageway of each holder, the rail segment is itself an elongated, generally tube-like structure which, at its greatest extent in transverse cross-section, measures roughly one inch (2.5 cm) and is shaped in such a way that it can be easily gripped by a young child.

### BRIEF DESCRIPTION OF DRAWINGS

Further details are explained below with the help of the examples illustrated in the attached drawings in which:

FIG. 1 is a perspective view of the handrail system according to the present invention, showing the handrail being used by a typical toddler;

FIG. 2 is an enlarged perspective view of a fragmentary portion of the handrail system according to FIG. 1, one of the balusters on which the handrail system is mounted being shown in dashed lines and forming no part of the invention;

FIG. 3 is a perspective view of a fragmentary portion of a rail segment in the handrail system according to FIG. 1;

FIG. 4 shows a transverse cross-section of the rail segment according to FIG. 3;

FIGS. 5 and 6 are front and side elevation views, respectively and on an enlarged scale, of a support bracket and a holding cup according to FIG. 1;

FIG. 7 is a top perspective view of the support bracket and holding cup according to FIG. 6;

FIG. 8 is a side perspective view, on a further enlarged scale, of the support bracket according to FIG. 6;

FIG. 9A shows, on an enlarged scale, an exploded view of a rail segment coupler and an end cap therefor, the coupler being connected in use to a terminal rail segment in the handrail system according to FIG. 1;

FIG. 9B is a perspective view showing the rail segment. coupler and the end cap according to FIG. 9A in assembled relation;

FIGS. 10, 11 and 12 are perspective views, on an enlarged scale, of the holding cup according to FIG. 6, the holding cup being shown with the centerline of its bifurcated structure oriented generally vertically, at a slight angle to the vertical, and generally horizontally, respectively;

FIG. 13 is a close-up perspective view of a wedge insertable between the support bracket and the holding cup according to FIG. 6, prior to the support bracket and the holding cup being clamped together onto a baluster of narrow transverse cross-section;

FIG. 14 is an exploded view of the wedge according to FIG. 13 in combination with the support bracket and the holding cup; and

FIG. 15 is a perspective view, on an enlarged scale, of the support bracket, the wedge, and the holding cup according to FIG. 14, the bracket, wedge and holding cup being shown in assembled relation when they are mounted on a wrought iron baluster which is illustrated by dashed lines and forms no part of the invention.

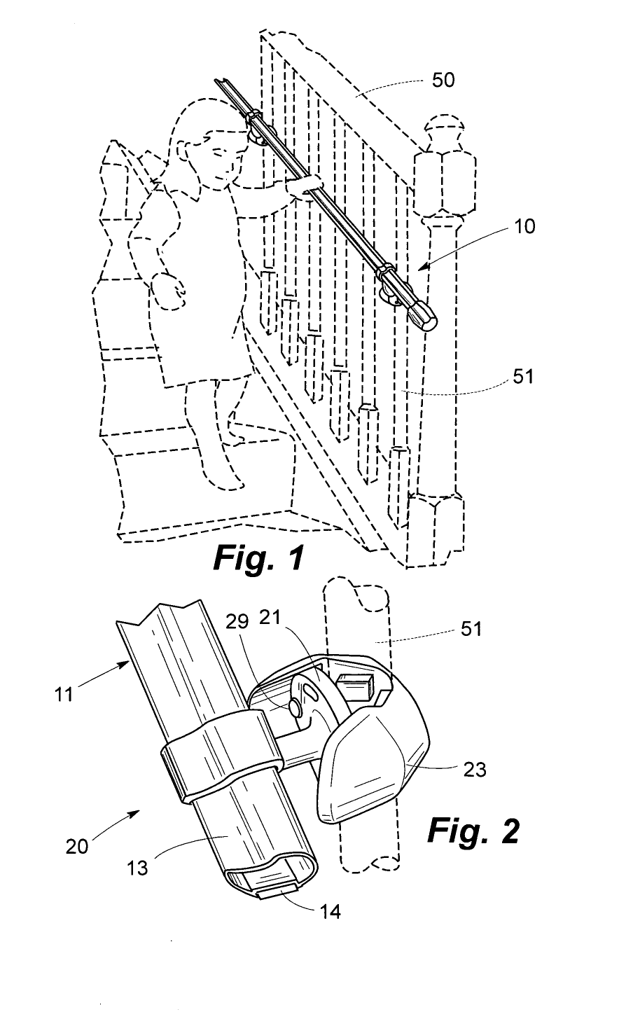

### BEST MODE FOR CARRYING OUT THE INVENTION

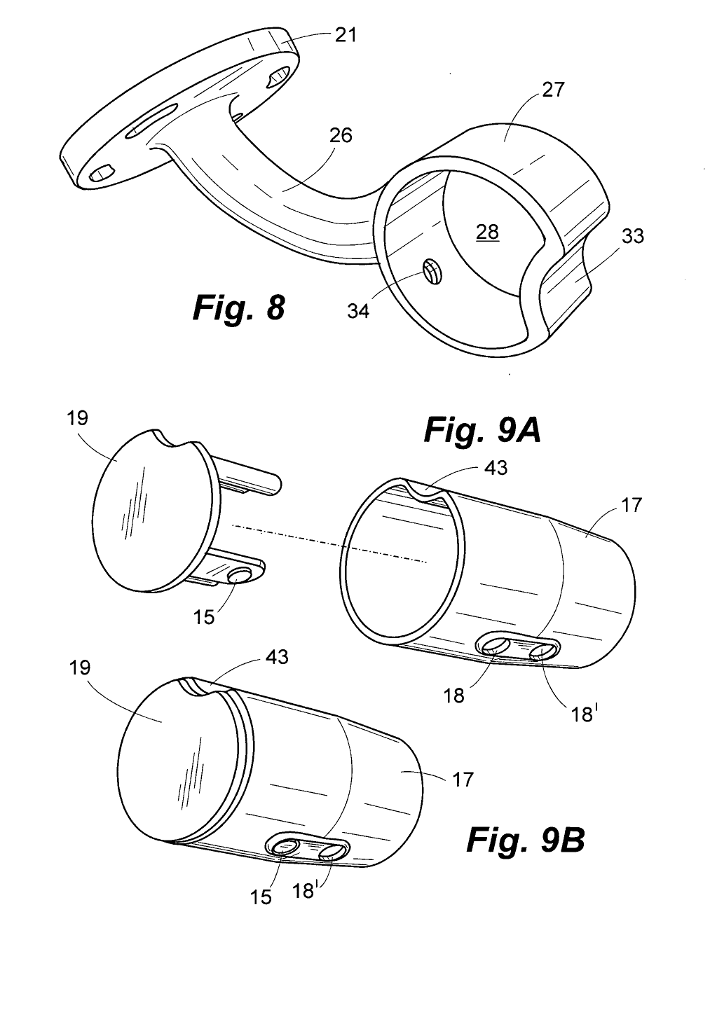

The improved toddler handrail system, indicated generally by the reference numeral 10, includes at least one rail segment 11 and one or more support brackets 20 and holding cups 23 with which the support brackets are paired. Each of the holding cups 23 comprises a bifurcated structure with a pair of opposing concave walls; and the support bracket 20 includes a rail segment holder 27 and a base (FIGS. 8, 10-12). Prior to use, the rail segment 11 is affixed to the rail segment holder 27 (FIG. 2).

In assembled relation, each support bracket 20 and the holding cup 23 with which it is paired are held together in such a way that they define a first through passageway 31 (FIG. 7). When the support bracket 20 and the holding cup 23 are not only held together in this way but also encircle a short portion of one of the balusters 51 of an existing handrail 50, they can be clamped onto the baluster, allowing one to readjust, over time, the height at which the rail segment 11 and its holder 27 are mounted.

Generally ring-like in shape, each rail segment holder 27 defines both a first thumb pocket 33 and a short, generally cylindrical through passageway 28 for slideably receiving the rail segment 11 prior to use. With its ends extending both fore and aft of the through passageway 28, the rail segment 11 is affixed to the holder 27 with the use of a screw (not shown) which engages a hole 34 formed in the holder (FIG. 8). The rail segment 11 so affixed can neither slip longitudinally relative to the holder 27 nor rotate within it. Moreover, in the preferred embodiment, the interior walls of the through passageway 28, in transverse cross-section, have the same shape as, but dimensions which are slightly larger than, the exterior surfaces of the rail segment 11. As a consequence, in assembled relation the first thumb pocket 33 is nested within a second thumb pocket 13 formed in the rail segment 11; and rotation of the latter within the holder 27 is prevented even when the rail segment is being slid longitudinally through the passageway 28 (FIGS. 4 and 6).

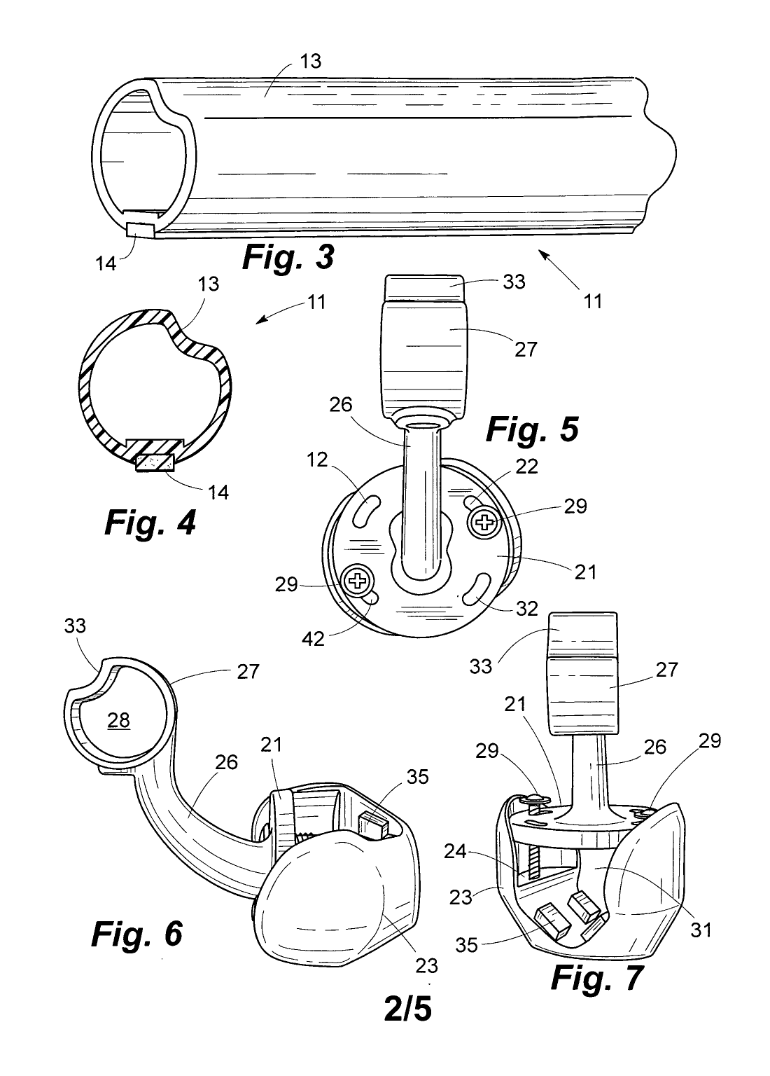

Formed as an elongated structure which is generally tube-like and circular in transverse cross-section, the rail segment 11 further defines an elongated groove for securing a rubber insert 14 (FIGS. 3 and 4). The rubber insert 14, like the first and second thumb pockets 33, 13 is provided to enhance the child's efforts to grip the rail segment 11, so that his hand grip is firmer and less prone to slippage.

Distal from the rail segment holder 27, the base of the support bracket 20 extends radially from its juncture with a curved beam 26 to form a flange 21. Receivable between the opposing concave walls of the holding cup 23, the flange 21 has a generally flat face bounded by a short side wall (FIG. 8). Rigidly attached to both the rail segment holder 27 and the flange 21, the curved beam 26 is preferably formed with them as a single unitary piece fabricated of plastic or metal.

In the preferred embodiment, the radius of curvature of the side wall of the flange 21 is approximately equal to the radii of curvature of the opposing concave walls of the holding cup 23. Moreover, the latter are spaced apart from each other by a distance which is wide enough to allow the side wall, when the flat face of the flange 21 is aligned parallel with the centerline of one of the balusters 51, to be slideably received between the opposing concave walls (FIG. 2).

Means for adjustably mounting the support bracket 20 on one of the balusters 51 includes not only the holding cup 23 with which the support bracket is paired but also screws or like fasteners 29. So that the fasteners 29 can be used to clamp the support bracket 20 and the holding cup 23 onto the baluster 51, the flange 21 defines a first set of elongated, curvilinear slots 12, 32 and preferably a second set of such slots 22, 42 as well. Like the slots 12, 32 in the first set, the slots 22, 42 oppose, and are formed generally concentrically with, each other (FIG. 5).

In addition to the fasteners 29, the means for adjustably mounting the support bracket 20 includes shoulders 24 within the holding cup 23 which define a pair of holes 25 with which only one of the sets of paired slots 12, 32; 22, 42 is alignable at any given time. Once the two slots in one or the other of these sets have been aligned with the holes 25, the fasteners 29 can then be fitted into the slots so aligned and threadedly engaged with the holes. The relative positions of the first and second sets of slots 12, 32; 22, 42 are such that they can be used with right-handed and left-handed handrails, respectively.

Extending inwardly from the shoulders 24 and like them spaced apart by a distance which is less than the width of the flange 21 are paired side walls 36. In the preferred embodiment, the side walls 36 are disposed parallel with each other and, juxtaposed between them and a curved interior end wall 37, are diverging side walls 30 (FIGS. 7, 10-12). Together with the shoulders 24, the flat face of the flange 21 and those portions of the opposing concave walls situated between the flange and the shoulders, the parallel side walls 36, diverging side walls 30 and curved interior end wall 37 define a through passageway 31 which can accommodate any one of a wide variety, with respect to both size and shape in transverse cross-section, of balusters 51 (FIG. 7).

In cases in which the dimensions in transverse cross-section of the baluster 51 are generally those in common use, the paired side walls 36 are spaced far enough apart to receive most of a short portion of the baluster. Moreover, the shoulders 24 are located within the bifurcated structure in such a position that the flange 21 is kept from coming into direct contact with the shoulders whenever the baluster 51 is encircled and the fasteners 29, threadedly engaged with the holes 25, are being tightened.

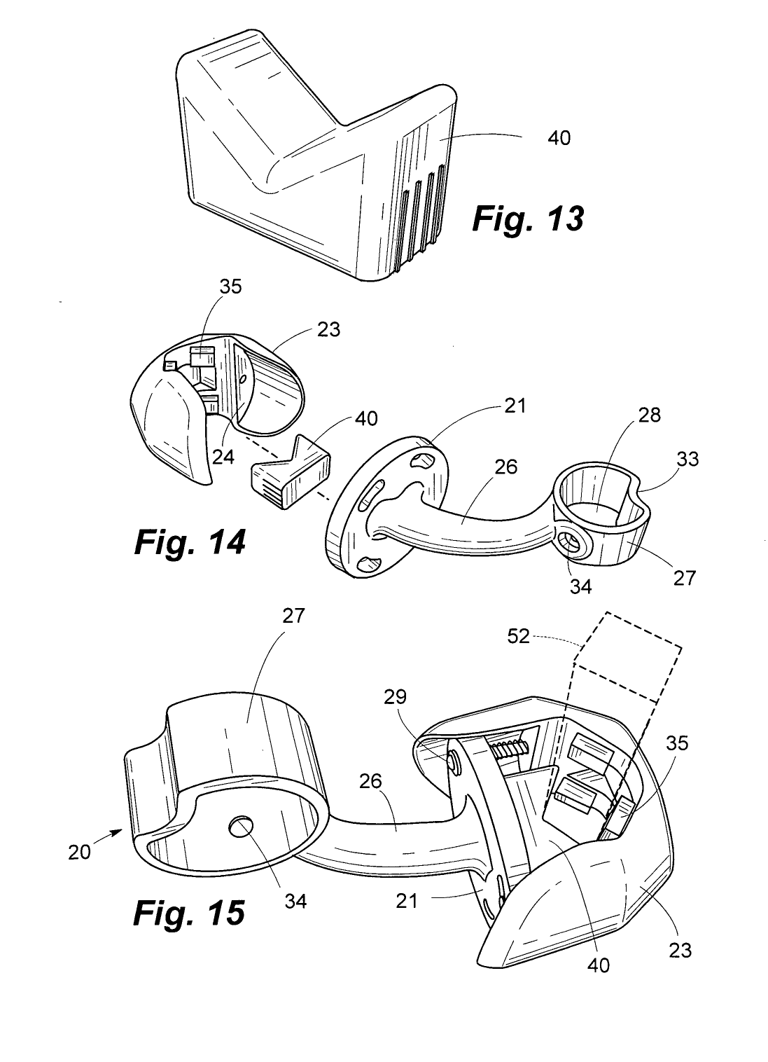

In situations involving a wrought iron baluster 52 or other baluster in which direct contact between the flange 21 and the shoulders 24 would be possible because of the narrow transverse cross-section of the baluster, a multi-faceted wedge 40 is provided (FIGS. 13-15). Formed of rubber or the like, the wedge 40 defines a V-shaped notch which is directed away from a flattened side wall. Insertable into the through passageway 31, the wedge 40 can be held in place there in such a way that when the V-shaped notch opposes the diverging side walls 30 of the bifurcated structure, the flat face of the flange 21 abuts the flattened side wall of the wedge. With the wedge 40 so held, one can, by tightening the fasteners 29, press it against the baluster 52 and, in the process, clamp the support bracket 20, the wedge, and the holding cup 23 onto the baluster (FIG. 15).

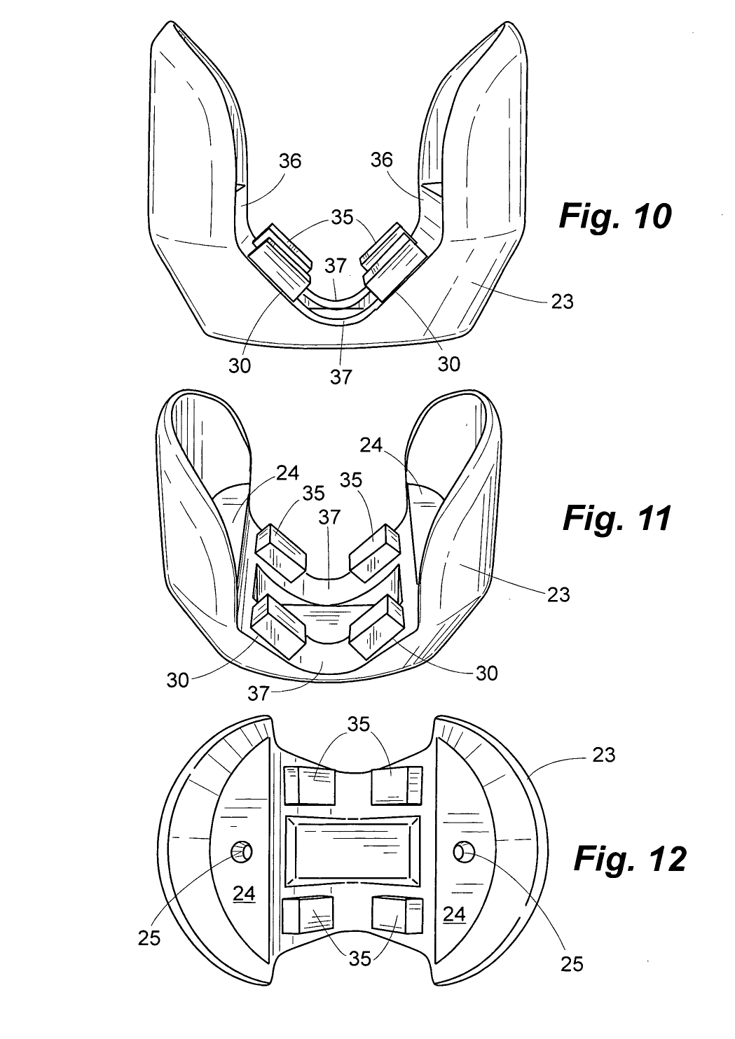

In the preferred embodiment, the holding cup 23 is a single unitary piece fabricated of plastic or metal; and its diverging side walls 30 are augmented with rubber pads 35 (FIGS. 10-12). The rubber pads 35 not only keep the holding cup 23 from marring the finish of the baluster 51 or otherwise damaging it when the support bracket 20 and the holding cup are clamped together onto the baluster but also the rubber pads increase the holding strength of the support bracket in combination with the holding cup.

### INDUSTRIAL APPLICABILITY

Prior to tightening the fasteners 29, one can, by rotating the flange 21 while it is received between the opposing concave walls of the holding cup 23, adjust the tilt of the support bracket 20. In this manner, any rail segment 11 affixed to the rail segment holder 27 can be brought into parallel alignment with the longitudinal centerline of the existing handrail 50. Once the fasteners 29 have been threadedly engaged with the holes 25 so as to clamp the flange 21 and the holding cup 23 together onto the baluster 51 or, alternately, the flange, the wedge 40, and the holding cup onto the baluster 52, the tilt of the support bracket 20 is determined by just where along the curved arc of the set of opposing slots 12, 32 or, alternately, slots 22, 42, the fasteners received therein are held in use.

Preferably manufactured in 4 foot (1.2 meter) lengths, two rail segments 11 can be joined together with the use of a rail segment coupler 17. Once the ends of two such rail segments 11 have been slip-fitted into the coupler 17, they are then locked onto it with screws (not shown) which are fitted into screw holes 18, 18′ formed in the coupler (FIG. 9A).

At the head and foot of a stairwell, the distal, otherwise empty end portions of the first and last rail segment couplers 17 are preferably fitted with closure caps 19 (FIG. 9B). Attached to each closure cap 19 is a plurality of extension arms slideably receivable within the empty end portion of one of the couplers 17. Means for snap-locking the closure cap 19 onto the coupler 17 includes a spring pin 15 which protrudes laterally from one of the extension arms. In assembled relation, the spring pin 15, once it has been snapped into one of the screw holes 18, 18′, firmly locks the closure cap 19 in place (FIGS. 9A, 9B).

It is understood that those skilled in the art may conceive other applications, modifications and/or changes in the invention described hereinabove. Any such applications, modifications or changes which fall with the purview of the description are intended to be illustrative and not intended to be limitative. The scope of the invention is limited only by the scope of the claims appended hereto.

1. In a handrail system including at least one rail segment adapted for use with an existing handrail supported by balusters, wherein the improvement comprises:
(a) a support bracket including a rail segment holder and a flange with a generally flat face, the support bracket terminating, distal from the rail segment holder, in the flange; the rail segment holder being affixed to the rail segment in use;
(b) a holding cup which includes a bifurcated structure having a pair of opposing concave walls between which the flange, prior to use, is slideably receivable; in use, the flange and the bifurcated structure encircling a short portion of one of the balusters; and
(c) means for pulling together the flange and portions of the bifurcated structure disposed inwardly of, and distal from, the flat face of the flange when the flange is slideably received between the opposing concave walls, so that the support bracket can be mounted on the short portion of the baluster when the baluster is encircled by the flange and the bifurcated structure.

2. The improvement according to claim 1 wherein the means for pulling together the flange and portions of the bifurcated structure comprises a pair of fasteners; wherein the holding cup further includes a pair of spaced apart shoulders which are joined to the opposing concave walls, the opposing concave walls terminating inwardly at their respective junctures with the shoulders; each shoulder defining a hole which is disposed proximate with the opposing concave wall contiguous thereto; and wherein the flange defines at least one pair of opposing elongated, curvilinear slots which are formed generally concentrically in the flat face of the flange; in assembled relation, each of the fasteners being received by one of the slots and threadedly engaging one of the holes.

3. In a handrail system for toddlers for use with a standard height handrail, the handrail system including at least one rail segment mountable below the standard height handrail at such a height that toddlers can grip the rail segment, the rail segment defining an elongated pocket for receiving a toddler's thumb, wherein the improvement comprises:
(a) a support bracket including a rail segment holder and a flange with a generally flat face, the support bracket terminating, distal from the rail segment holder, in the flange; the rail segment holder being affixed to the rail segment in use;
(b) a holding cup which includes a bifurcated structure having a pair of opposing concave walls between which the flange, prior to use, is slideably receivable; and
(c) means for pulling together the flange and portions of the bifurcated structure disposed inwardly of, and distal from, the flat face of the flange when the flange is slideably received between the opposing concave walls.

4. The improvement according to claim 3 wherein the means for pulling together the flange and portions of the bifurcated structure comprises a pair of fasteners; wherein the holding cup further includes a pair of spaced apart shoulders which are joined to the opposing concave walls, the opposing concave walls terminating inwardly at their respective junctures with the shoulders; each shoulder defining a hole which is disposed proximate with the opposing concave wall contiguous thereto; and wherein the flange defines at least one pair of opposing elongated, curvilinear slots which are formed generally concentrically in the flat face of the flange; in assembled relation, each of the fasteners being received by one of the slots and threadedly engaging one of the holes.

5. The improvement according to claim 3, which further comprises an elongated rubber insert, the rail segment further defining an elongated groove for receiving the rubber insert, the elongated pocket and groove being spaced apart and disposed generally upwardly and downwardly, respectively, when the rail segment is mounted in use, so that when the toddler grips the rail segment and his thumb is inserted into the elongated pocket, his fingertips can press against the elongated rubber insert, thereby facilitating the toddler's maintaining a firm grip on the rail segment.

6. In a handrail system adapted for use with a stairway, the handrail system including at least one rail segment and a support bracket, the support bracket having both a rail segment holder and a flange, the support bracket terminating, distal from the rail segment holder, in the flange, the rail segment being affixed to the rail segment holder in use, wherein the improvement comprises:
(a) a holding cup which includes a structure having concave walls between which the flange, prior to use, is slideably receivable;
(b) means for adjusting the tilt of the support bracket prior to use, so that the rail segment can be brought into parallel alignment with the longitudinal centerline of the stairway, the tilt adjusting means comprising the flange having a generally flat face in which is defined at least one pair of opposing elongated, curvilinear slots which are formed generally concentrically in the flat face; and
(c) means, including fasteners receivable by the slots, for securing the flange to the structure.
